(19) United States
(12) Patent Application Publication
(10) Pub. No.: US 2020/0122921 A1
(43) Pub. Date: Apr. 23, 2020

(54) APPARATUS FOR PREPARING HERBAL INFUSIONS

(71) Applicant: CambDEV Limited, Waterbeach (GB)

(72) Inventors: Hugh MALKIN, Waterbeach (GB); Graham Scott GUTSELL, Waterbeach (GB); Timothy Charles BULLOCK, Waterbeach (GB); Ian Michael Riorden GEORGE, Waterbeach (GB); Nicholas James HASTINGS, Waterbeach (GB)

(21) Appl. No.: 16/692,191

(22) Filed: Nov. 22, 2019

Related U.S. Application Data
(63) Continuation of application No. PCT/GB2018/051380, filed on May 22, 2018.

(30) Foreign Application Priority Data
May 23, 2017 (GB) 1708215.7

(51) Int. Cl. B65D 85/804; A47J 31/36; A23F 5/08; A23L 2/56; A23L 2/60

(52) U.S. Cl. CPC B65D 85/804; A47J 31/3623; A23L 2/60; A23L 2/56; A23F 5/08

(57) ABSTRACT

Described is a cartridge containing non-coffee plant materials, said cartridge having walls defining a chamber in which the plant materials are confined, the cartridge being adapted to serve as a grinding and extraction chamber for the plant materials.

### CROSS-REFERENCE TO RELATED APPLICATIONS

This application is a continuation of International Application No. PCT/GB2018/051380, filed May 22, 2018, which claims priority to GB Application No. 1708215.7, filed May 23, 2017, under 35 U.S.C. § 119(a). Each of the above-referenced patent applications is incorporated by reference in its entirety.

### BACKGROUND OF THE INVENTION

### Field of the Invention

This invention relates to cartridges, apparatus and processes for producing and dispensing non-coffee herbal infusions by extraction within a prepacked cartridge.

### Background to the Invention

Non-coffee herbal infusions are amongst the world's most popular and widely enjoyed beverages, thanks to their almost unlimited organoleptic qualities and the absence of the often undesirable stimulatory effect of coffee-derived caffeine

### SUMMARY

In a first aspect there is provided a cartridge containing plant materials, said cartridge having walls defining a chamber in which the plant materials are confined, the cartridge being adapted to serve as a grinding and/or extraction chamber for the plant materials.

Other aspects of the invention are as defined in the claims appended hereto.

### Definitions and General Preferences

As used herein, the term “herbal infusion” defines a phytochemical extract obtained by contacting plant materials other than seeds of plants of the genus Coffea, with a hot or boiling solvent (such as water, oil, alcohol or mixtures thereof). Thus, the term is used sensu lato to include non-coffee infusions (produced by steeping the plant materials in hot solvent), decoctions (produced by boiling the plant materials in the solvent) and percolate (produced by passing the hot or boiling solvent through the plant materials).

The term “plant materials” is used herein in a broad sense to encompass not only plants and plant parts sensu stricto, but also fungi, bacteria, algae and mixtures thereof and excluding seeds of plants of the genus Coffea. Thus, the term “plant materials” is used interchangeably herein with the term “non-coffee plant materials”. The non-coffee plant materials may also be processed in various ways prior to use according to the invention, and so the plant materials for use according to the invention include dried, roasted, milled, ground, washed and fermented plant materials, provided that plants and plant parts, including seeds, of plants of the genus Coffea are excluded.

The herbal infusions of the invention therefore include leaf extracts (including tea, orange and peppermint), root extracts (including chicory), fruit/berry extracts (e.g. apple, rose-hip, raspberry, cherry, apricot, banana or citrus, such as lemon), herbs (for example mint), spices (for example, chilli and cinnamon, nutmeg), nuts (e.g. almond, hazelnut, walnut, peanut, pecan, macadamia and pistachio), coconut, flowers (including lime and camomile), seeds (including cocoa beans and vanilla pods) and mixtures of the foregoing. Thus, herbal infusions of the invention include both classic products made from plant parts obtained from a single plant, for instance peppermint, as well as blends of extracts of different herbs and/or fruits. The herbal infusions of the invention may also be extracts of medicinal plants.

The term phytochemical is used herein in a broad sense to encompass any chemical constituent of a plant as herein defined, including macromolecules and small molecules. Important examples include alkaloids (for example pyrrolidines, piperidines, pyrrolizidine, indolizidines, tropanes and nortropanes), carbohydrate analogues, phenolic compounds, terpenoids, enzyme inhibitors, glycosides, nucleotides, amino acids, lipids and sugars.

The term cartridge is a term of art defining a single-use container comprising a chamber containing plant material which is adapted to be inserted into an automatic or semi-automatic infusion dispensing apparatus whereat hot water is introduced into the chamber and the plant material extracted and dispensed, after which the cartridge is discarded.

A single-serve cartridge is a term of art for a cartridge containing a single portion of plant material in the chamber, i.e. containing a quantity of plant material sufficient for a single beverage.

As used herein, the term roasted as applied to plant material defines plant material that has been roasted to some degree. The term roasting is to be interpreted accordingly.

The term fluidized bed roasting is used herein to define a roasting process whereby plant material is at least partially levitated by a stream of heated air in which the degree of roasting is controlled by variation of the temperature of the air and the duration of heating.

The term fast fluidized bed roasting as used herein defines fluidized bed roasting (as defined above) in which the temperature of the heated air exceeds 250° C. (for example, about 300° C.), so permitting roasting to proceed at an accelerated rate. Fast fluidized bed roasting may also be advantageously applied to dried and/or pre-heated plant material (as herein defined), since its use in relation to such materials may permit lower air velocities, smaller air ducts and/or reduced roasting temperatures and/or times.

The term in situ roasting, as used herein, defines a process in which roasting of the plant material is carried out within the cartridge chamber.

The term remote roasting, as used herein, defines a process in which roasting of the plant material is carried out outside of the cartridge chamber. Remote roasting therefore requires that the cartridge of the invention be adapted to serve as both a grinding and extraction chamber for the plant material, but also to permit transfer of the material to a separate roasting chamber and to receive the roasted material once roasting is completed.

The degree of roasting depends inter alia on factors such as temperature and duration of roasting.

As used herein, the term “unroasted plant material” defines plant materials that are unroasted (as defined above), but which may have been subject to certain heat treatments to yield the dried or pre-heated materials defined below. The term therefore includes “green” plant materials.

However, it should be noted that the term “unroasted plant material” encompasses not only fresh, green plant materials, but also “dried” and “pre-heated” plant materials.

In this regard, the term “dried plant material” defines unroasted plant material which, while being unroasted (as defined above), has been dried to a moisture content of less than 10% (for example within the range of 0.5% to 9.0% or 1.0 to 5.0% by weight). Such dried materials are relatively brittle and shrunken relative to green plant materials, and are therefore easier to grind in the unroasted state. They may also exhibit favourable roasting and extraction properties.

Furthermore, it should be noted that the term “unroasted plant material” encompasses not only green and dried plant materials (as explained above), but also “pre-heated” plant materials.

In this regard, the term “pre-heated plant material” defines unroasted plant material which, while being unroasted (as defined above), has nevertheless been heated to a point beyond being merely dried (as defined above), but which has not yet been roasted (as also defined above). Pre-heating green or dried plant materials before grinding greatly facilitates subsequent grinding operations and so may be useful in some embodiments of the invention.

As used herein, the term “part-roasted plant material” defines material which has been heated to a point beyond being merely dried or pre-heated (as defined above), such some (but not all) of the material (or some but not all of any individual plant part) has been at least lightly roasted. Such beans may be useful in embodiments where particularly rapid roasting is required and/or the roasting temperatures employed are relatively low and/or of short duration. Part-roasted plant materials also include materials which comprise a mixture (i.e. a blend) of unroasted and roasted plant materials.

As used herein, the term “whole plant material” is used herein to define whole plant materials which have not been cracked, broken up into fragments or ground. The terms unroasted, dried unroasted, roasted and pre-heated as defined above and used in relation to whole plant materials are to be interpreted to mean that the various operations are performed on whole plant materials as starting material, irrespective of the effects of such operations on the physical characteristics of the beans.

The term “cracked plant material” is used herein to define unground plant beans (for example cocoa beans) which have been fragmented and/or cracked to some degree, but are not ground (i.e. have not been subject to course (or finer) grinding, as herein defined).

The term “ground plant material” is used herein to define plant materials which are in a fragmented form, for example having an average particle diameter of about 1.5 mm (“course ground”), about 1.0 mm (regular ground), about 0.75 mm (drip ground), about 0.4 mm (fine ground) or about 0.2 mm (espresso ground). Since plant materials are typically ground after roasting, ground beans are typically also roasted to some degree. However, ground unroasted, ground dried and ground pre-heated plant materials are also contemplated for use according to the invention.

Thus, as used herein, the term “unground plant material” defines a class of plant material which includes whole plant materials (as define above) and cracked plant materials (as defined above).

As used herein, the term “brewing spike” defines a component of the apparatus or cartridge of the invention which comprises means for perforating a wall of the cartridge thereby permitting the flow of water through said wall. In cases where the brewing spike forms part of the cartridge, it is preferably associated with retaining means providing a loose fit such that perforation may be achieved by a force exerted on the brewing spike by a component of the apparatus when in use as part of the system of the invention.

The brewing spike may also comprise channels for delivering water through the perforations in the wall and/or for conducting the herbal infusion out of the chamber via the perforations.

The means for perforating a wall of the cartridge may take the form of one or more spikes, preferably a plurality of spikes. In cases where the brewing spike also comprise channels for delivering water through the perforations in the wall and/or for conducting brewed herbal infusion out of the chamber, the perforating means may advantageously take the form of one or more hollow spike(s), needle injector(s) or cannula(e).

In cases where the brewing spike comprise channels for conducting the herbal infusion out of the chamber via the perforations introduced into the chamber wall, the brewing spike may advantageously be integrated with a brew spout for dispensing the infusion.

In cases where the brewing spike comprise channels for delivering hot water through the perforations in the wall and into the cartridge chamber, the brewing spike may advantageously be integrated with a plunger adapted to exert force on a wall of the chamber (or directly on the plant material contained therein). In such embodiments, the plunger may incorporate a grinding head.

As used herein, the term “grinding head” defines a component of the cartridge or apparatus of the invention which comprises means for exerting (and/or transmitting, via contact with a cartridge chamber wall) a crushing and/or grinding force on the plant materials within the cartridge chamber.

Thus, the grinding head may be a component of the apparatus, adapted to enter the cartridge (e.g. via an opening therein or after a wall is removed therefrom) and directly contact the plant material.

Alternatively, or in addition, the grinding head may be a component of the cartridge, when it may be adapted to engage with a plunging means in the apparatus which drives it into contact with the plant materials in the cartridge chamber when in use as part of the system of the invention.

Thus, the present invention contemplates the use of a grinding head adapted to enter the cartridge and directly exert force on the plant material in the cartridge, the grinding head being wholly an element of the apparatus and adapted to directly contact the plant materials when in use as part of the system of the invention.

The means for exerting said crushing and/or grinding force may comprise milling means. In this context, the milling means are substantially rigid features of the grinding head which contact a plant material and transmit a concentrated force thereto, facilitating its fragmentation.

The milling means preferably comprises the perforating means of the brewing spike.

In some embodiments, the grinding head comprises part or all of a wall of the cartridge of the invention. In such embodiments, the grinding head may be adapted to releasably couple with a plunger of the apparatus of the invention.

In embodiments where the brewing spike is integrated with a plunger incorporating a grinding head, the means for exerting said crushing and/or grinding force may comprise the perforating means of the brewing spike.

Thus, in some embodiments, the apparatus of the invention comprises two different brewing spikes:
(a) a first brewing spike integrated with a plunger incorporating (or releasably coupled with) a grinding head; and
(b) a second brewing spike integrated with a brew spout for dispensing the herbal infusion comprising channels for conducting the infusion out of the chamber via perforations introduced into a chamber wall.

### Grinding

The cartridge of the invention may contain unground plant materials and may be adapted to serve as a grinding chamber for the plant materials.

In embodiments where the plant materials in the cartridge are unroasted plant materials, grinding is typically executed after roasting. However, in some embodiments, a pre-grinding step is carried out in order to facilitate a later roasting step (by increasing the surface area of the plant materials exposed to heat). In such embodiments, the plant materials are preferably dried or pre-heated (particularly when the plant materials in the cartridge are green plant materials, which have a relatively high water content and which are liable to form undesirable pastes when subject to grinding).

As explained above, the ground plant materials of the invention are in a fragmented form. Thus, the term “grinding” as used herein is to be interpreted broadly, to cover any form of processing which results in fragmentation of the plant material.

It will therefore be appreciated that the ground plant materials may be prepared by simple crushing—roast plant materials are friable and the application of a crushing force with no rotational grinding may be sufficient to fragment the roasted materials into fragments sufficiently small as to constitute ground plant materials as herein defined. In such cases, the grinding means may take the form of a moveable (preferably rigid) portion of the cartridge wall, such that a crushing force may be transmitted to the plant material confined in the chamber

However, grinding is typically more effective if a crushing force is coupled with rotational grinding. Here, the cartridge may be provided with a movable wall or part thereof which is rotatable relative to the chamber such that a rotational grinding force may be exerted on the material confined in the chamber. Rotational grinding is particularly advantageous in circumstances where percolated plant materials are required.

Crushing/grinding (as described above) may be executed with or without the use of milling means. Milling means are substantially rigid features (of the cartridge and/or apparatus) which contact the plant material and transmit a concentrated force thereto, facilitating its fragmentation. In preferred embodiments, the milling means may comprise one or more ribs, recesses, channels, teeth, ridges, spikes, blades or protrusions. The milling means may for part of the cartridge (e.g. taking the form of elements disposed on the chamber-proximal surface of at least one wall).

It will be appreciated that the nature of the milling means will depend on the physical condition of the unground plant materials contained in the cartridge (and in particular, whether they are: (a) whole or cracked; and (b) unroasted, dried, pre-heated or roasted).

It will also be appreciated that whole plant materials may require coarser, harder and/or sharper milling means. In contrast, green plant materials (which have a relatively high water content and are difficult to grind while avoiding the formation of a paste) are typically (though not necessarily) pre-heated or roasted prior to grinding.

### Extraction

The cartridge of the invention is adapted to serve as an extraction chamber for the plant materials.

The temperature of the solvent, the pressure at which it is introduced into the chamber and the flow rate through the chamber all affect the quality of the herbal infusion.

In embodiments where water is used as the extracting solvent, the temperature of the hot water is typically between 91 and 94° C. (though this will depend on whether the extraction chamber is under vacuum, when lower temperatures may be effective).

The water pressure selected affects the flow rate of the water through the ground plant material, but many other factors also contribute including inter alia the particle size distribution of the grounds, their density, the strength of infusion required and the desired extraction yield.

The flow rate can be controlled, e.g. by varying the pressure of the hot water, to control the infusion intensity and avoid under-extraction (which may be associated with loss of flavour) or over-extraction (which may be associated with undesirable organoleptic qualities, such as bitterness).

The target total dissolved solids (TDS) in the dispensed infusion will depend on the style of beverage required, and can be readily controlled by inter alia varying the total volume of hot water passed through the cartridge chamber and the dose of plant material in the chamber.

It will be appreciated that while the cartridge chamber is sealed to an extent that is at least sufficient to confine the plant materials, the seal need not be sufficient to contain the hot water used for extraction (especially at the higher pressures described above). In such embodiments, the cartridge holder adapted to receive and secure the cartridge when in use provides such a seal, and ensures that the hot water pumped into the chamber passes through the plant material (and does not leak away from the chamber).

Thus, the cartridge holder is preferably adapted to serve as a pressure jacket to contain the pressurized hot water during injection into the chamber of the cartridge and through the plant material.

Various different means for achieving such a seal are described in the art, for example in U.S. Pat. Nos. 4,895,308, 5,402,707, WO93/17932, U.S. Pat. No. 5,656,316, WO2014/128658, WO2014/091439, US2005/0150391 and EP1554958.

### Roasting

The present invention contemplates the use of roasted plant materials, and in such embodiments a roasting step is not required.

However, even in cases where the cartridge of the invention contains roasted plant materials, it may still be advantageous to include a heating step (for example, to generate and/or liberate volatile oils which may enhance the flavour and aroma of the infusion). In such cases, the apparatus or system may comprise heating means. Suitable heating means may be the roasting oven/roasting process as herein described, but adapted for lower temperature heating (e.g. in the form of a fluidized bed heating chamber). Such heating chambers may be vented, to enhance the aroma during infusion.

Any means of heating may be employed, including microwave heating, radiant heating, conductive heating, convection heating (e.g. by a flow of hot air) or any combination thereof.

The heating means (and heating parameters, including duration and temperature) will also be selected according to the bean to be roasted. For example, whole plant materials may require exposure to higher temperatures and/or longer heating cycles, whereas fragmented plant materials may require lower temperatures and/or heating durations (since they typically offer a greater surface area to the heat source).

The roasting process may include a preliminary heating stage in which moisture is driven out of the plant material. In embodiments where green plant materials are employed, this moisture content can be as much as 12% by weight.

The roasting process may also include a pre-grinding or crushing step, for example to increase the surface area of the plant material exposed to heat (and so accelerate roasting).

Roasting may be conveniently achieved by oven roasting or fluidized bed roasting, as described in more detail below. In either case, the roasting may be preceded by an initial microwave heating step (e.g. to dry or pre-heat the plant material and/or drive off moisture).

Roasting may be accompanied or followed by a degassing/venting step, since roasting is may be associated with the release of hot gases (mainly carbon dioxide) from the plant material.

### Oven Roasting

The plant material may be roasted by radiant heat, for example in a drum heated in an oven. Such embodiments employ remote roasting configurations (described in more detail herein). However, care must be taken not to scorch and so min the plant material, and smoke and oils generated in the process remain in contact with the plant material and can confer a disagreeable taste.

### Fluidized Bed Roasting

In certain embodiments of the invention, the plant material is subjected to fluidized bed roasting (as herein defined). Fluidized bed roasting (for example as described in U.S. Pat. No. 5,394,623) avoids the problems associated with smoke and oils generated during oven roasting.

However, care must be taken to avoid scorching the plant material. Thus, in embodiments where fluidized bed roasting is employed according to the invention, provision for quenching the material after roasting is completed may be provided. This may be achieved by the introduction of a stream of ambient air or by spraying with water. Such techniques are described, for example, in U.S. Pat. Nos. 4,484,064, 5,185,171, 3,964,175 and 5,394,623.

Fluidized bed roasting may be readily implemented in remote roasting systems (as described above), since: (a) the stream of hot air may be used to drive the plant material from the chamber of the cartridge and transport it to a separate roasting chamber (so obviating the need for a mechanical transfer ram, shuttle hopper or caddy); and (b) the use of a separate roasting chamber permits the use of larger airflow ducts (and hence higher volumetric flow rates) than could be achieved when using the cartridge itself as a roasting chamber.

However, fluidized bed roasting may also be implemented in situ. For example, in embodiments where part or all of at least one wall of the cartridge is reversibly openable or removable, sufficiently high volumetric flow rates into and out of the cartridge may be achieved to fluidize the plant material in situ without the need for additional ducting in the cartridge.

Fluidized bed roasting may be applied according to the invention to unground plant materials (as defined herein).

Fluidized bed roasting may also be advantageously applied to dried and/or pre-heated plant materials (as herein defined), since its use in relation to such materials may permit lower air velocities, smaller air ducts and/or reduced roasting temperatures and/or times.

Fast fluidized bed roasting (as used herein defined) may be advantageously used in circumstances where accelerated roasting is required. Fast fluidized bed roasting may be applied to dried and/or pre-heated plant materials (as herein defined), since its use in relation to such materials may permit lower air velocities, smaller air ducts and/or reduced roasting temperatures and/or times.

Fluidized bed roasting may also be employed to remove chaff expelled from the plant material as it expands during roasting, so reducing contamination from smoke and oils generated in the roasting process. This may conveniently be achieved by filtering the hot air to remove chaff produced during roasting.

### In Situ Roasting

As explained above, the present invention contemplates cartridges containing roasted plant materials, and in such embodiments a roasting step is not required.

However, in embodiments where the cartridge of the invention contains unroasted plant materials (as herein defined), the plant material may be roasted prior to extraction.

The roasting may be conveniently carried out within the cartridge chamber. In such embodiments, the cartridge is preferably formed of heat-resistant material, for example being able to withstand heating to at least 196° C. (and preferably to temperatures approaching 250° C.).

Suitable cartridge materials for systems using in situ roasting include paper, cardboard and coated paper or cardboard (for example metal-, polytetrafluoroethylene- (PTFE-) or nitrocellulose-coated paper or cardboard).

It will be appreciated that the use of dried, pre-heated or part-roasted plant material may be advantageously used in circumstances where in situ roasting is employed, since their use may permit reduced roasting temperatures and/or times.

Thus, any limitations imposed by heat sensitivity of the cartridge may be at least partially mitigated by the selection of dried, pre-heated, part-roasted, cracked, pre-ground and/or crushed plant materials.

Any means of heating may be employed for in situ roasting, including microwave heating, radiant heating, conductive heating, convection heating (e.g. by a flow of hot air) or any combination thereof. In situ roasting may also include a microwave heating step for rapid heating and/or drying of the beans (which may be followed by radiant, conductive or convective heating to complete the roasting process).

However, preferred according to the invention is in situ fluidized bed roasting (as described above).

### Remote Roasting

As an alternative to in situ roasting, the plant material may be removed from the cartridge, roasted in a separate roasting chamber, and then returned to the cartridge chamber for grinding and extraction.

Any suitable means for removing the material from the cartridge may be employed, including gravity, inertial force (e.g. centrifugal or linear), rams (including air rams), pushers, shunts, conveyors, shuttle hoppers, suction or any combination thereof.

Remote roasting permits greater latitude in the election of cartridge materials: any limitations imposed by heat sensitivity of the cartridge may be circumvented by remote roasting configurations. It is therefore particularly suited to applications where compostable/biodegradable materials are to be sued to manufacture the cartridge (see below).

However, it will be appreciated that remote roasting need not necessarily imply complete thermal insulation of the cartridge/cartridge holder from the roasting chamber: in many cases the roasting chamber and cartridge chamber/cartridge holder are in close physical proximity (for example, to facilitate transfer of plant material therebetween), so that the cartridge itself may be indirectly heated during roasting by heat from the roasting chamber.

Remote roasting also facilitates fluidized bed roasting (as described above), and in such cases the hot air flow required for fluidizing the plant material may also be used to move the material from the cartridge chamber to the roasting oven and/or from the roasting oven to the cartridge chamber.

Systems according to the invention configured for remote roasting comprise a roasting chamber. This may take the form of a roasting oven (as described above), or may comprise a roasting chamber including an air-permeable member configured to support the plant materials thereupon; a hot air inlet disposed so as to introduce a stream of hot air into said chamber, through said permeable member, so as to pass through and fluidize said plant materials; and an air outlet disposed so as to direct said stream of air out of the chamber after it has passed through the plant material.

Remote roasting is particularly advantageous when high and/or rapid roasting is required (for example when dark roasts (such as Italian) and/or when transient very high temperatures (up to 300° C. or higher) are employed to accelerate roasting.

### Additives

In some embodiments the cartridge may contain additives confined in the cartridge chamber together with the plant materials. In such embodiments, the cartridge is adapted to serve as an extraction chamber for the additives as well as the plant materials.

These optional additives may be selected from flavouring agents, preservatives, foaming agents (as described in e.g. WO2013034520), anti-foaming agents (e.g. surfactants), foam stabilizers (e.g. as described in US2010310746), colouring agents and mixtures thereof.

Suitable flavouring agents include those selected from: cocoa, caramel, vanilla, tea, chicory, fruit/berry extracts (e.g. raspberry, cherry, apricot, banana or citrus, such as lemon), herbs (for example mint), spices (for example, chilli and cinnamon, nutmeg), liqueurs (for example brandy and Amaretto), spirits (e.g. rum and brandy), salt, sugar, scorched sugar, honey, nuts (e.g. almond, hazelnut, walnut, peanut, pecan, macadamia and pistachio), coconut and mixtures of the foregoing.

The additives may be in powdered or granular form (for example, having been spray-dried). In some cases (such as fruit/berry extracts, honey and liqueurs) they may be provided as a syrup or as a glaze or coating on the plant materials and/or the walls of the cartridge chamber.

### Cartridge Geometry

The cartridges of the invention may contain unground plant materials. Unground plant materials may be difficult to extract, and so the cartridge of the invention may be adapted to serve as both an extraction and grinding chamber for the plant materials.

The latter requirement may be reflected in the provision of milling means on the chamber-proximal surface of at least one wall, where the milling means is suitable for grinding the plant materials within the chamber. The milling means may comprise one or more ribs, recesses, channels, teeth, ridges, spikes, blades or protrusions and it will be appreciated that the nature of the milling means will depend on the physical condition of the unground plant materials contained in the cartridge (and in particular, whether they are: (a) whole or cracked; and (b) unroasted, dried, pre-heated or roasted).

In general, in embodiments where the cartridge contains unroasted plant materials, the beans are roasted (or at least pre-heated) prior to grinding.

A requirement that the cartridge of the invention be adapted to serve as both a grinding and extraction chamber for the plant materials may alternatively or in addition be reflected by the provision of cartridge walls characterized in that part or all of at least one of said walls is moveable relative to the other walls. In such embodiments, said part or all of at least one wall is moveable such that the volume of the chamber may be reduced. This permits a crushing force to be applied to the beans in the chamber, which may result in effective grinding of the plant material (especially in cases where the materials are roasted, as explained above).

However, grinding is typically more effective if a crushing force is coupled with rotational grinding. Thus, in some embodiments, said part or all of at least one wall is rotatable relative to the chamber (and so to the plant material contained therein). In such embodiments, a milling means (as described above) is advantageously provided to the chamber-proximal surface of the rotatable wall.

In the latter embodiments, the moveable wall may be substantially planar and/or rigid, so facilitating the transfer of a crushing and or rotational grinding force to the plant material in the chamber.

In embodiments where rotational grinding is employed, the geometry of the chamber may advantageously be adapted to facilitate the rotation of part or all of a chamber wall. For example, the cartridge may be cylindrical, substantially cylindrical or frustoconical, having top and bottom walls defining the ends of the cylinder or bases of the frustum, the top and/or bottom walls being: (a) moveable and/or rotatable; and/or (b) provided with milling means as described above.

The internal volume of the cartridge chamber is a function of the amount of plant material present and of the volume of water to be introduced into the chamber for extraction. The volume of water will vary according to the style of infusion, but is typically 0.5 to 3 times the volume of the plant material.

In embodiments where remote roasting is employed, the cartridge of the invention is configured such that the plant material can be removed from the cartridge chamber, and then returned after roasting. This requirement may be reflected in the provision of one or more openable walls (or portions thereof).

### Cartridge Materials

As explained above, the cartridge of the invention may be adapted to serve as both a grinding and extraction chamber for the plant materials. The latter requirement may be reflected in the materials used, since extraction may require the injection of pressurized hot water into the cartridge chamber.

Thus, the cartridge is preferably constructed from materials that are heat resistant to at least 80° C., and preferably to at least 100° C. Those skilled in the art will be able to select an appropriate material from a wide variety of suitable materials described in, for example, U.S. Pat. Nos. 4,895,308, 5,402,707, WO93/17932, U.S. Pat. No. 5,656,316, WO2014/128658, WO2014/091439, US2005/0150391 and EP1554958.

It will be appreciated that any single cartridge may be constructed from a variety of different materials, and may for example employ different materials for the moveable/rotatable walls, slideable plugs, cap or piston element (where provided).

Suitable materials include: metals (such as aluminium, usually having a thickness of between 20 μm and 100 μm); plastics (such as polypropylene, polyethylene terephthalate (PET) and metallized PET); metal-plastic composites (such as plastic-coated aluminium); cardboard, polymer-coated cardboard and cardboard-metal or cardboard-plastic composites.

Suitable composite/laminate materials include those provided with an oxygen barrier layer (such as ethylene vinyl alcohol, polyvinylidene chloride and/or SiO₂), including barrier-layer coated cardboard/aluminium/plastic or cardboard/plastic laminates.

In certain embodiments, the cartridge cap or plugs are formed of polypropylene (PP), while the walls are formed of polyethylene terephthalate (PET). In such embodiments, the cap is advantageously injection moulded, while the cartridge itself is blow-moulded.

As explained above, in certain embodiments of the invention the cartridge comprises unground and unroasted plant materials, and in such embodiments (for example where in situ roasting is contemplated) the cartridge may be adapted to serve as a grinding, extraction and roasting chamber for the plant materials.

The latter requirement may be reflected in the materials used for the cartridge, since roasting may require that the plant material be heated to at least 196° C. (and typically to temperatures approaching 250° C.). Suitable materials include paper, cardboard and coated paper or cardboard (for example metal-, polytetrafluoroethylene- (PTFE-) or nitrocellulose-coated paper or cardboard).

The cartridge may advantageously comprise a filter for retaining grounds and other particulates released during extraction of the plant material within the cartridge chamber. In such embodiments, the filter is preferably located the bottom wall and may comprise a layer of filter paper or woven or non-woven fibres based on PET or PP. Such filters may be bonded or welded to the chamber-proximal surface of the bottom wall of the chamber.

### Biodegradeability

The cartridge according to the invention may be advantageously manufactured from a compostable/biodegradable material. Such materials are described in detail in WO2014/128658, and in particular at pages 4-6 thereof (the content of which is incorporated herein by reference).

Such cartridges preferably meet European standard EN 13432.

### BRIEF DESCRIPTION OF THE DRAWINGS

Embodiments of the present invention will now be described by way of example with reference to the accompanying drawings in which:

FIG. 1 is a cutaway perspective view of a first embodiment of a cartridge according to the invention.

FIG. 2 illustrates schematically a process for roasting, grinding, brewing and dispensing a cocoa bean infusion using the cartridge shown in FIG. 1 in apparatus adapted for use therewith.

FIG. 3 illustrates schematically a second embodiment of a cartridge according to the invention.

FIG. 4A illustrates schematically a process for roasting, grinding, brewing and dispensing cocoa using the cartridge shown in FIG. 3 in apparatus adapted for use therewith.

FIG. 4B illustrates schematically an alternative process for roasting, grinding, brewing and dispensing cocoa using the cartridge shown in FIG. 3 in apparatus adapted for use therewith.

FIG. 5A is a cutaway perspective view of a third embodiment of a cartridge according to the invention.

FIG. 5B is a perspective view of the embodiment shown in FIG. 5A.

FIG. 6A is a cutaway perspective view of a system comprising a cartridge according to the third embodiment in association with apparatus according to the invention.

FIG. 6B is a perspective view of the brew spike/spout of the system shown in FIG. 6A.

FIG. 6C is a schematic view of the brew spike/spout when engaged with the cartridge in the system shown in FIG. 6B.

FIG. 7 illustrates schematically a process for roasting, grinding, brewing and dispensing cocoa using the cartridge/system shown in FIGS. 5 and 6 in apparatus adapted for use therewith.

FIG. 8 shows plan and section views of a cartridge for use in the system of the invention in closed configuration.

FIG. 9 shows top and bottom perspective views of the cartridge shown in FIG. 8.

FIG. 10 shows plan, sectional and top and bottom perspective views of another embodiment of a cartridge of the invention.

FIG. 11 shows plan, sectional and top and bottom perspective views of yet another embodiment of a cartridge of the invention.

### DETAILED DESCRIPTION OF CERTAIN INVENTIVE EMBODIMENTS

### Example 1: In Situ Roasting

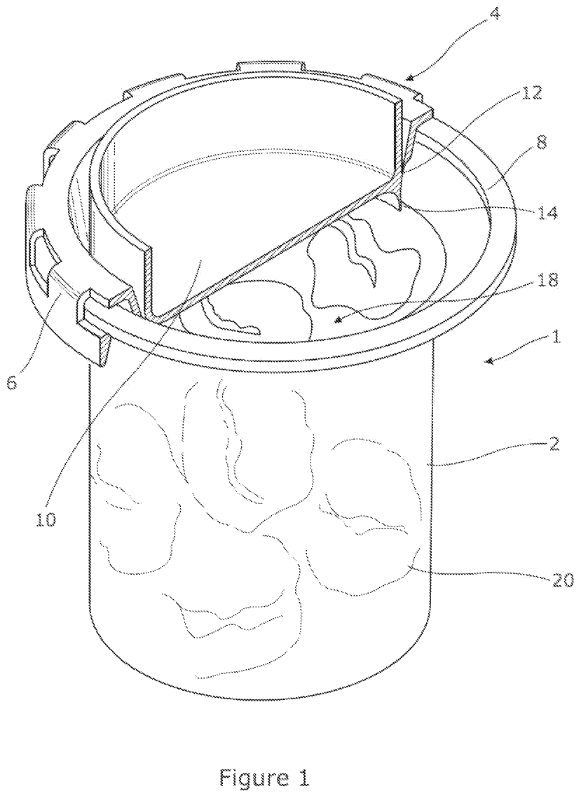

Referring to FIG. 1, the cartridge (1) comprises cylindrical side walls (2), a fixed bottom wall (not shown) and a top wall in the form of a cap (4) comprising an outer retainer means (6) for securing the cap to the top of the cartridge by a “snap-on” engagement with a flange on the side walls (8) adapted to engage the outer retainer means (6) of the cap.

The cap (4) has an inner piston element (10) detachably connected to the retainer means by a frangible tear strip (12). The piston element (10) features a peripheral sealing portion (14) adapted to contact the inner surface of the side walls (2) of the cartridge thereby forming a seal, so that the piston element (10) and cartridge chamber may function as a piston and cylinder assembly when the piston element is detached from the retainer means (6) by breakage of the frangible tear strip (12).

Unground (whole) and unroasted (green) plant material in the form of seeds (20) are shown in ghost.

It will therefore be appreciated that the cartridge walls define a roasting, grinding and brewing chamber (18) in which the seeds are confined.

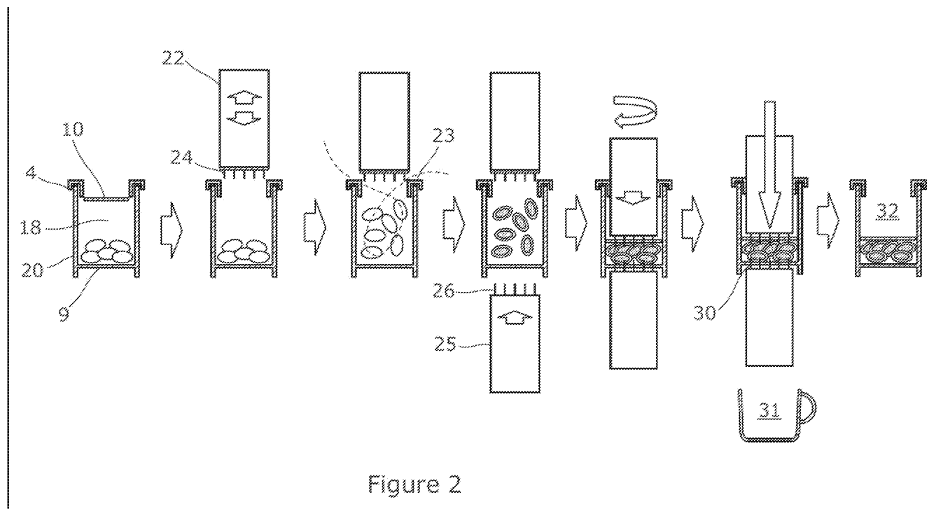

Referring now to FIG. 2, and using the numbering for the components of the cartridge adopted in the description of FIG. 1 (above), the cartridge (1) is inserted into the cartridge holder (not shown) of the apparatus. An upper ram (22) having a number of brewing spikes (24) is then lowered onto the inner piston element (10), piercing it with the brewing spikes (24) and coupling therewith (aided by vacuum pressure generated by pump (not shown)).

The frangible tear strip (not shown) is then broken by rotation of the upper ram (22) together with the coupled piston element (10). The upper ram (22) is then lifted so that the coupled piston element (10) is removed from the cap (4), so opening the chamber and creating a peripheral vent (23).

The vent (23) is sufficiently large as to allow the introduction of a flow of hot air (broken arrow) at a volumetric flow rate sufficient to fluidize the seeds in the chamber, thereby effecting rapid, in situ fluidized bed roasting of the seeds within the cartridge chamber.

During this process, the capsule walls are cooled by a cooling element (not shown), while steam and aroma (shown by the arrows) escape via the vent (23).

A lower ram (25) having a number of cannulae (26), is then lifted against the fixed bottom wall (9), which is pierced by the cannulae (26) such that they protrude slightly through the bottom wall and come into contact with the seeds in the chamber. At the same time, the upper ram (22) together with the coupled piston element (10) is lowered and so re-inserted into the chamber to close the chamber. The roasted seeds are then rapidly degassed via the brewing spikes by the application of a vacuum thereto.

The upper ram (22) is then driven towards the bottom wall, during which process the piston element (10) and brewing spikes (24) are brought into contact with the roasted seeds confined therein, thereby crushing the roasted seeds. The upper ram is then rotated, exerting a rotational grinding force on the crushed seeds via the protruding brewing spikes (24) and lower protruding cannulae (26).

This processes described above yields freshly roasted seeds (30) confined within the chamber (18) of the cartridge.

Hot water (93° C.) is then pumped (at a pressure of 5 bar) into the extraction chamber via the brewing spikes (24) in the upper ram (22) (shown by the arrow). The water is forced around the grounds (30), extracting the herbal brew as it flows towards the cannulae (26) in the lower ram. The herbal infusion then flows out of the cannulae into a cup (31) via a brew spout (not shown).

The upper ram (22) and lower ram (25) are then detached from the cartridge and the spent cartridge containing wet, compressed grounds (32) is then ejected from the cartridge holder into a waste compartment (not shown).

### Example 2: Remote Oven Roasting

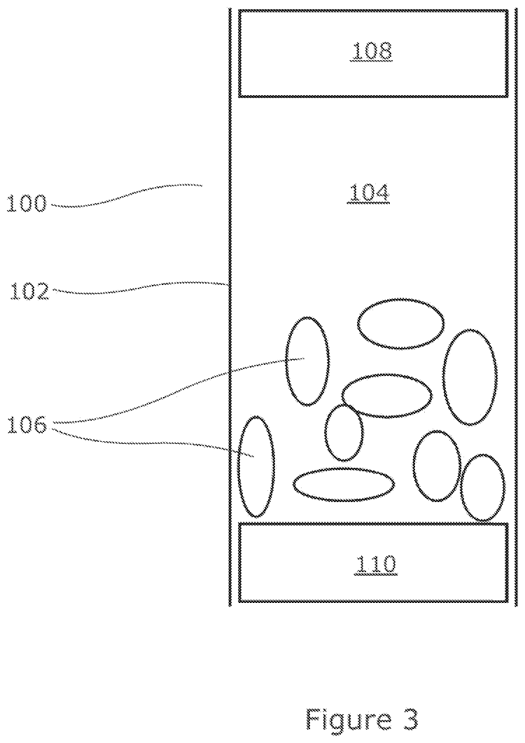

Referring now to FIG. 3, the cartridge (100) takes the form of a cylinder with cylindrical side walls (102) and top and bottom walls defining a chamber (104) containing unground (whole) and unroasted (green) plant materials in the form of seeds (106). The top and bottom walls are each in the form of upper and lower plugs slidably fitted within the chamber (108 and 110, respectively).

### Shuttle Hopper Transfer

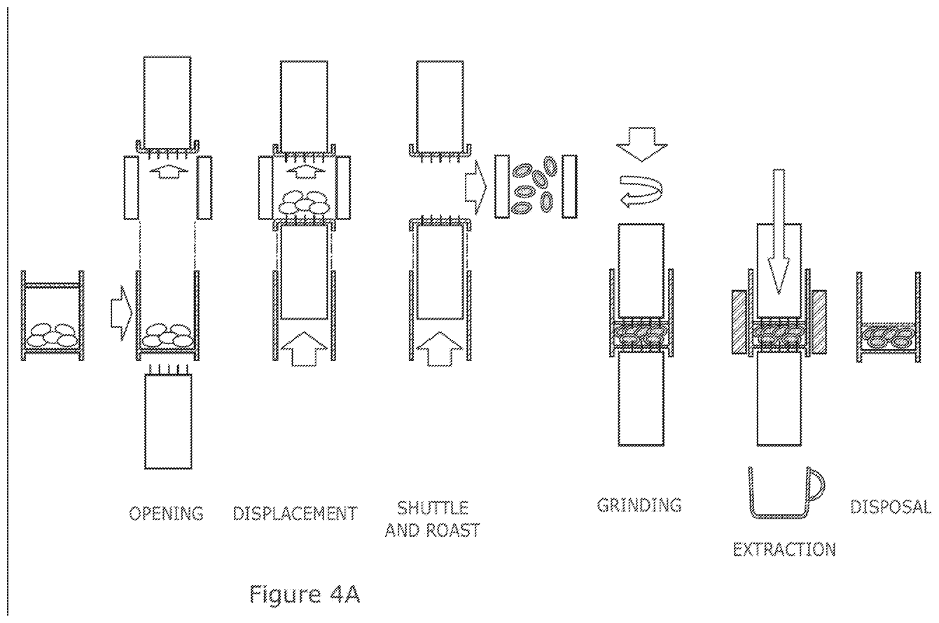

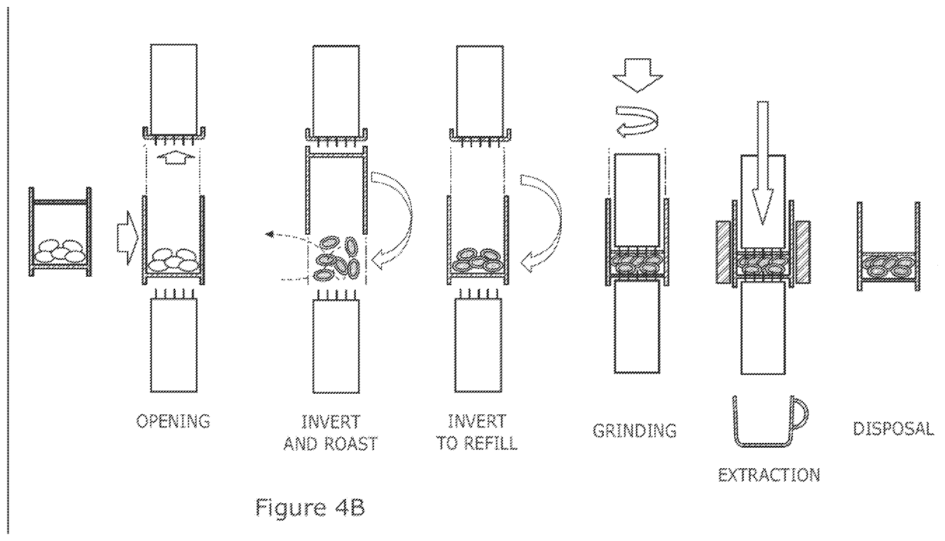

Referring now to FIG. 4A, and for clarity omitting all reference numerals (since the components will be recognized from the description given above for FIG. 2), the cartridge is inserted into the cartridge holder of the apparatus. The cartridge is then opened by removal of the upper plug with an upper ram having a number of brewing spikes which pierce the upper plug (thereby coupling upper ram and upper plug).

A lower ram having a number of cannulae is driven against the lower plug, which is pierced by the cannulae such that they protrude slightly through the lower plug and come into contact with the seeds in the chamber. The lower ram slides the lower plug past the upper end of the side walls of the chamber so displacing the seeds into a shuttle hopper.

The shuttle hopper containing the beans is then moved away from the top and lower plugs and the walls of the hopper are then heated to roast the seeds, while steam and aroma escape via a vent (not shown).

After cooling, the hopper is returned to its original location such that the roasted seeds are again located between the upper plug and lower plugs. The upper ram is then driven towards the lower plug, during which process the roasted seeds are crushed and brought into contact with the protruding brewing spikes and lower protruding cannulae. At the same time the upper and lower plugs, with the roasted seeds between them, are pushed through the hopper, past the upper end of the side walls of the cartridge and back into the chamber, so that the roasted seeds are returned to the cartridge chamber.

The upper ram then drives, in turn, the top plug (108) against the roasted seeds (106), and the roasted seeds against the lower plug (110), thereby crushing the roasted seeds, while rotation thereof exerts a rotational grinding force on the crushed seeds via the protruding brewing spikes and lower protruding cannulae.

This process yields fresh roasted seeds confined within the chamber of the cartridge.

Hot water (93° C.) is then pumped (at a pressure of 5 bar) into the extraction chamber via the brewing spikes in the upper ram (shown by the arrow). The water is forced around the grounds, extracting the herbal brew as it flows towards the cannulae in the lower ram. The brewed herbal infusion then flows out of the cannulae into a cup via a brew spout (not shown).

The upper ram and lower ram are then detached from the cartridge and the spent cartridge containing wet, compressed grounds is then ejected from the cartridge holder into a waste compartment (not shown).

### Gravity Transfer by Inversion

As an alternative to the process described above in relation to FIG. 4A, the seeds may also be transferred from the cartridge chamber to a remote roasting oven by a gravity driven process shown schematically in FIG. 4B. Again, for clarity all reference numerals have been omitted (since the elements will be recognized from the description given above for FIG. 2).

Here, the cartridge is inserted into the cartridge holder (not shown) of the herbal infusion making apparatus. The cartridge holder has an upper oven portion. An upper ram having a number of brewing spikes removes the upper plug and the cartridge holder and oven are then inverted, causing the seeds to fall by gravity out of the cartridge chamber and into the oven portion, where they are roasted.

After roasting, the cartridge holder and oven are returned to their original position, causing the roasted seeds to fall back into the cartridge chamber.

The upper ram, coupled to the upper plug, is then driven towards the lower plug, thereby crushing the roasted seeds, while rotation thereof exerts a rotational grinding force on the crushed seeds via the protruding brewing spikes of the upper ram and the protruding cannulae of the lower ram.

This process yields fresh roasted grounds confined within the chamber of the cartridge.

Hot water (93° C.) is then pumped (at a pressure of 5 bar) into the extraction chamber via the brewing spikes in the upper ram (shown by the arrow). The water is forced around the grounds, extracting the herbal brew as it flows towards the cannulae in the lower ram. The brewed herbal infusion then flows out of the cannulae into a cup via a brew spout (not shown).

The upper ram and lower ram are then detached from the cartridge and the spent cartridge containing wet, compressed grounds is then ejected from the cartridge holder into a waste compartment (not shown).

### Example 3: Remote Fluidized Bed Roasting

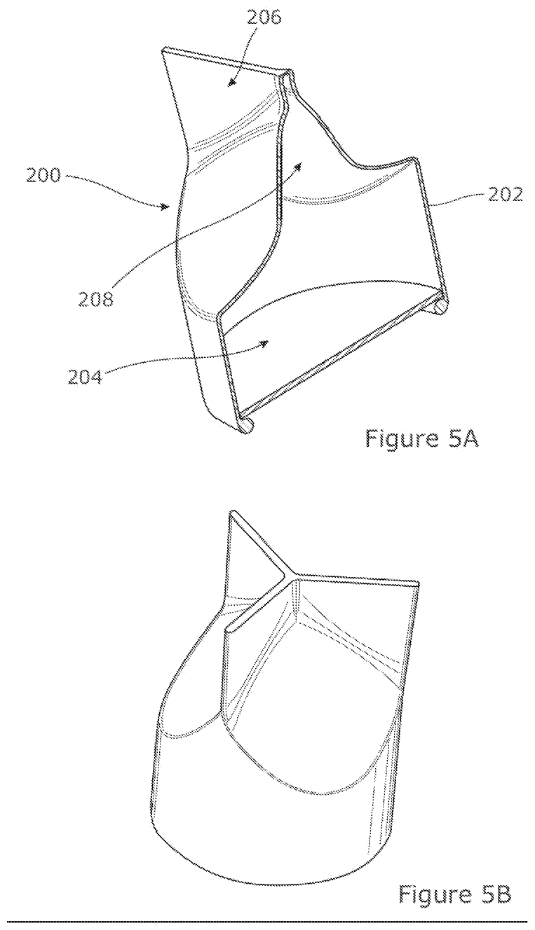

Referring now to FIG. 5A, the cartridge (200) takes the form of a cylinder with cylindrical side walls (202), a bottom wall (204) slidable against the side walls (202) and a 3-pointed crimped and welded top wall (206) defining a chamber (208) containing unground (whole) and unroasted (green) plant material in the form of seeds (not shown). The cartridge is formed of cardboard having an aluminium coating on the inner walls.

The 3-pointed crimped top wall (206) is shown more clearly in FIG. 5B.

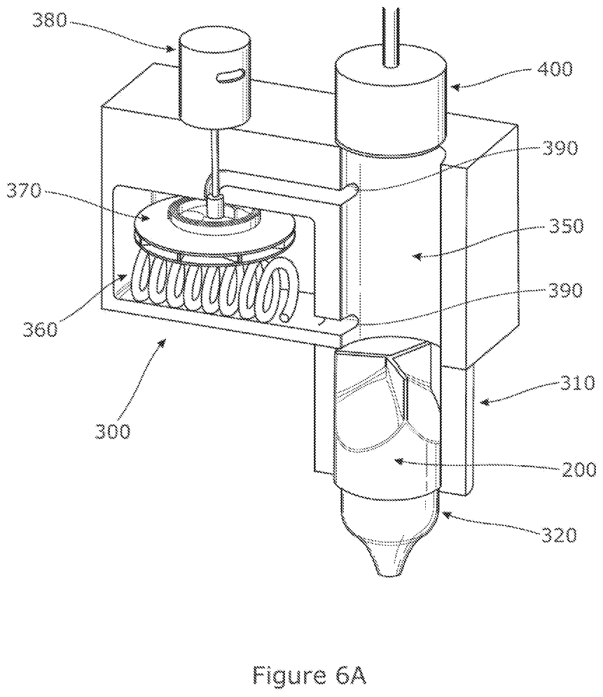

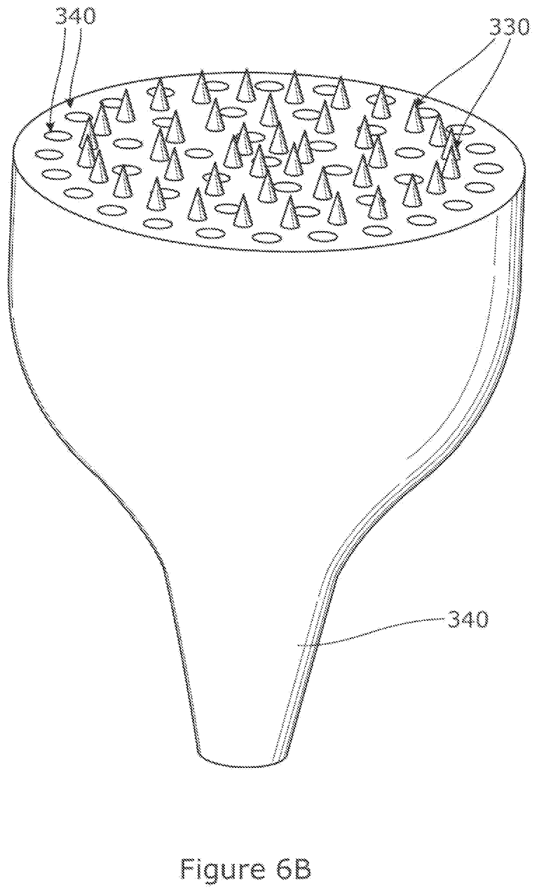

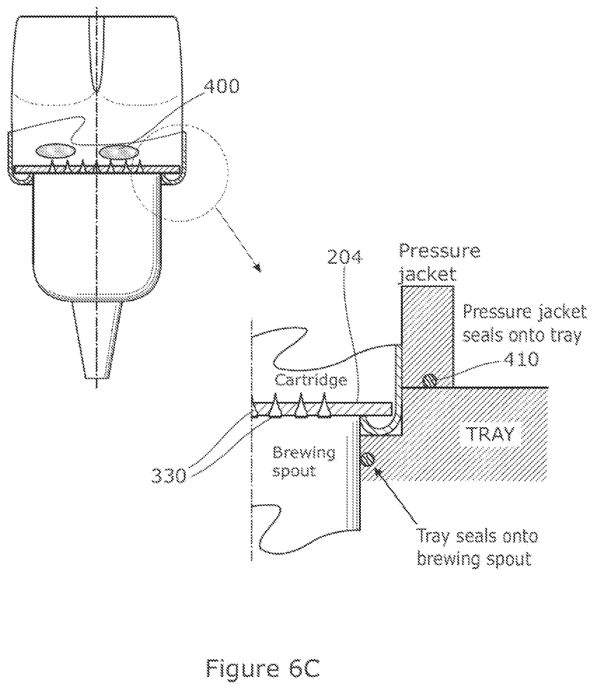

Referring now to FIG. 6A, the cartridge (200) is shown in conjunction with apparatus (300) for roasting, grinding, brewing and dispensing a herbal infusion for use with the cartridge (200), the cartridge (200) shown located in a cartridge holder (310) which is water-tight and adapted to serve as a pressure jacket to contain the pressurized hot water during injection into the chamber of the cartridge and through the plant material grounds. The bottom wall of the cartridge (not shown) is engaged with a brewing spike integrated with a brew spout (320).

The integrated brew spike/spout (320) is shown more clearly in FIG. 6B. The brew spike/spout (320) comprises a number of spikes (330) and a number of channels (340) for conducting brewed herbal infusion out of the chamber via the perforations introduced by the spikes (330) into the bottom wall (204) of the cartridge. The brewing spike is integrated with a brew spout (340) for dispensing the herbal infusion.

Above the cartridge holder (310) is a roasting chamber (350) into which air heated by heating element (360) is circulated by fan (370) driven by motor (380) via ducts (390).

Grinding plunger (400) is adapted to descend and rotate, to grind the roasted seeds. It comprises feed means (not shown) for introducing pressurized hot water into the chamber of the cartridge (200) and is in fluid communication with a source of pressurized hot water (not shown).

The engagement of the bottom wall (204) of the cartridge with the brew spike/spout (320) and the cartridge holder (310) is shown more clearly in FIG. 6C. This shows the spikes (330) perforating the bottom wall (204) of the cartridge such that they can contact the seeds (400) in the chamber. The expanded area shows sealing means (410) between brew spike/spout (320) and cartridge holder (310).

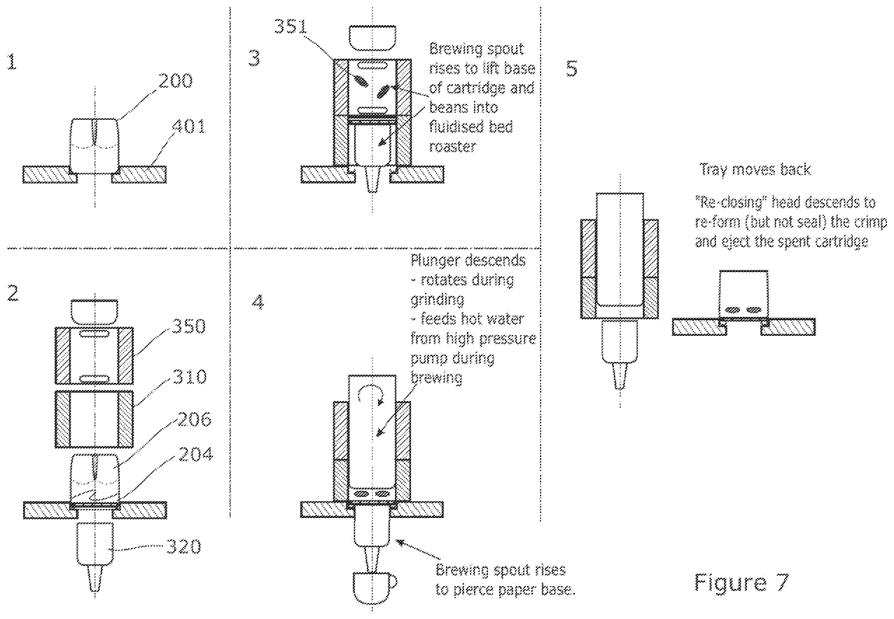

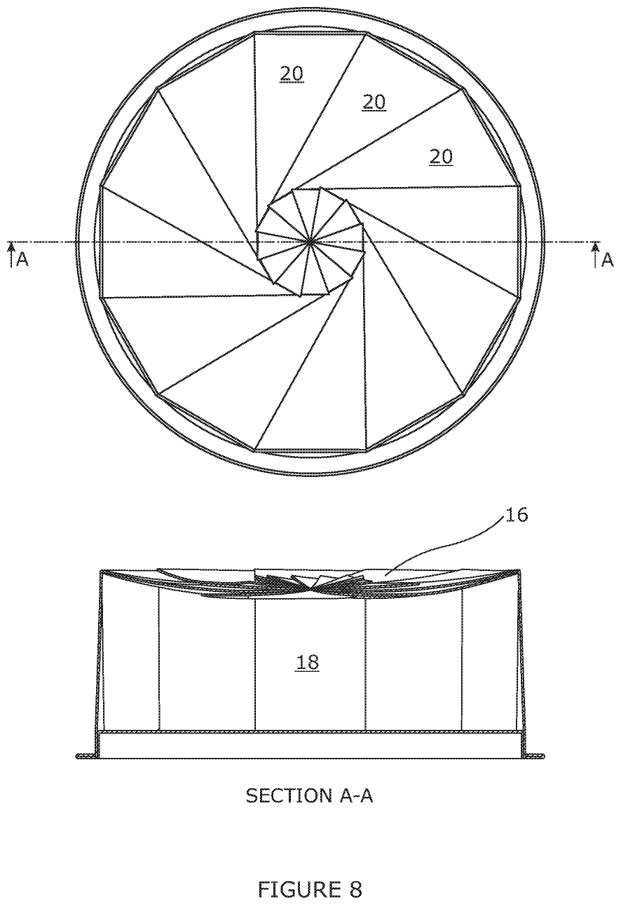

Referring now to FIG. 7, the cartridge (200) is loaded into a cartridge tray (401) by the user, and the tray then moved into position beneath cartridge holder (310) and roasting chamber (350). The brewing spike/spout (320) then rises to slide the bottom wall (204) towards the roasting chamber, driving the seeds (not shown) against the welded top (206), thereby breaking the welds, opening the top (206) and moving the seeds (351) into the roasting chamber (350).

Hot air at about 300° C. is then circulated through the roasting chamber by fan (370), fluidizing the seeds and rapidly roasting them.

After roasting, the seeds (351) are driven back into the chamber by grinding plunger (391), which compresses the roasted seeds against the brewing spike/spout (320), pushing them together with the brewing spike/spout (320) back into contact with the tray (401). The grinding plunger is then rotated to grind the roasted seeds.

This process yields fresh roasted seed grounds confined within the chamber of the cartridge.

Hot water is then fed through the grinding plunger (391) from a high pressure pump (not shown), forcing the hot water through the ground seeds and extracting a herbal infusion which is delivered to the user via the brew spike/spout (320). The machine then automatically cleans the grinding plunger while a reclosing plunger (not shown) reforms (but does not re-weld) the crimp of the top wall (206), so that the spent grounds and cartridge can be ejected into a waste compartment (not shown) without user intervention.

### Example 4: Remote Fluidized Bed Roasting with a Cartridge Having a Folded Closure

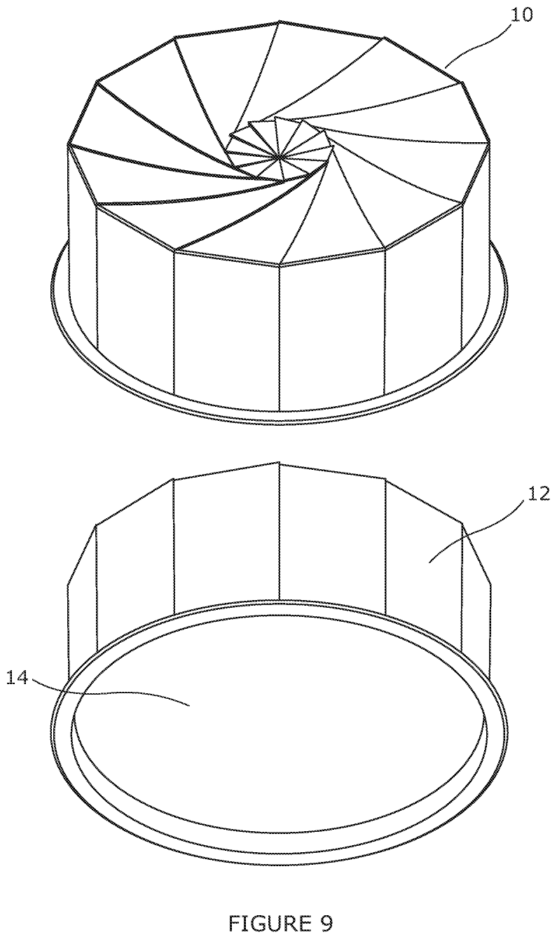

Referring now to FIGS. 8 and 9, the cartridge (10) is substantially cylindrical with substantially cylindrical side walls (12), a bottom wall (14) slidable against the side walls (12) and a reversibly openable top wall (16). The walls define a chamber (18) containing unground (whole) and unroasted (green) plant materials in the form of seeds (not shown). Part-roasted seeds may also be used. The cartridge is formed of cardboard.

The reversibly openable top wall (16) is formed by a number of sequentially overlapping hinged flaps (20).

This cartridge may be used in a remote fluidized bed roasting system in an analogous fashion to that described for the crimped and welded cartridge as described in Example 3.

It should be noted that the hinged flaps need not be refolded into a sequentially overlapping configuration after extraction: all that is required is that the spent seed grounds be substantially retained by the refolded flaps within the cartridge chamber prior to ejection into the waste compartment.

### Example 5: Remote Fluidized Bed Roasting with a Cartridge Having a Single Flap Closure

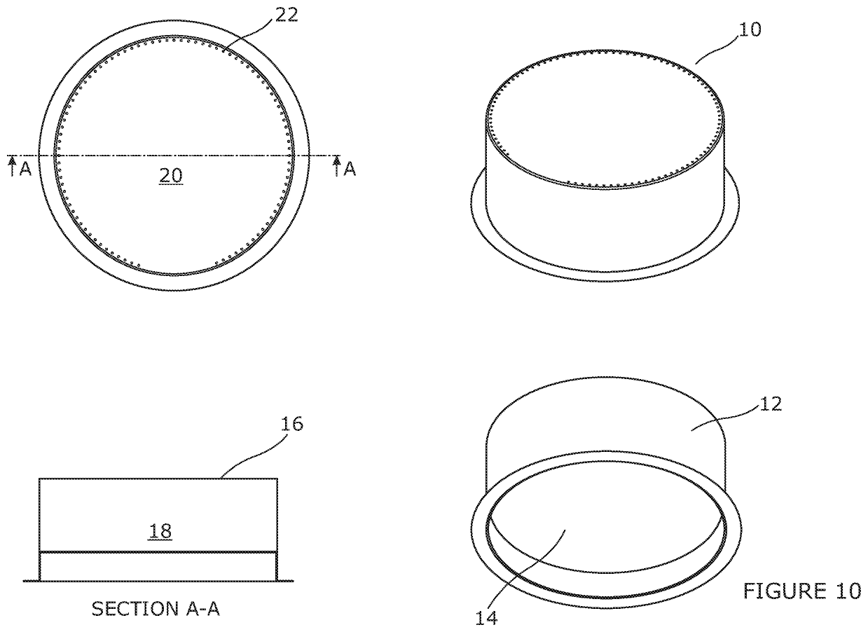

Referring now to FIG. 10, the cartridge (10) is substantially cylindrical with substantially cylindrical side walls (12), a bottom wall (14) slidable against the side walls (12) and a reversibly openable top wall (16). The walls define a chamber (18) containing unground (whole) and unroasted (green) plant materials in the form of seeds (not shown). Part-roasted seeds may also be used. The cartridge is formed of cardboard.

The reversibly openable top wall (16) is formed by a hinged flap (20), releasably connected to said cartridge wall by a perforated tear-line (22).

This cartridge may be used in a remote fluidized bed roasting system in an analogous fashion to that described for the crimped and welded cartridge as described in Example 3.

It should be noted that the hinged flaps need not be precisely refolded after extraction: all that is required is that the spent seed grounds be substantially retained by the refolded flaps within the cartridge chamber prior to ejection into the waste compartment.

### Example 6: Remote Fluidized Bed Roasting with a Cartridge Having a Two-Leaf Door Closure

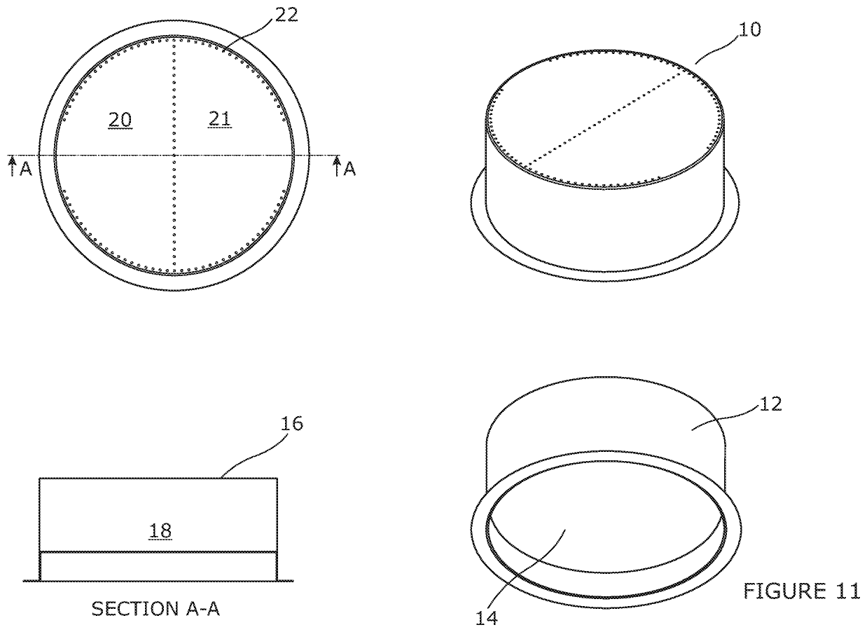

Referring now to FIG. 11, the cartridge (10) is substantially cylindrical with substantially cylindrical side walls (12), a bottom wall (14) slidable against the side walls (12) and a reversibly openable top wall (16). The walls define a chamber (18) containing unground (whole) and unroasted (green) plant materials in the form of seeds (not shown). Part-roasted seeds may also be used. The cartridge is formed of cardboard.

The reversibly openable top wall (16) is a folded closure is in the form of two opposed hinged flaps (20 and 21) configured as a two-leaf door, each door releasably connected to said cartridge wall by perforated tear-lines (22 and 23).

This cartridge may be used in a remote fluidized bed roasting system in an analogous fashion to that described for the crimped and welded cartridge as described in Example 3.

It should again be noted that the hinged flaps need not be precisely refolded after extraction: all that is required is that the spent seed grounds be substantially retained by the refolded flaps within the cartridge chamber prior to ejection into the waste compartment.

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

What is claimed is:

1.-46. (canceled)

47. A cartridge containing non-coffee plant materials, said cartridge having walls defining a chamber in which the plant materials are confined, wherein: (a) part or all of at least one wall is reversibly openable such that a plunger may be introduced into the cartridge chamber to apply a crushing force to the plant materials confined in the chamber, and (b) the reversibly openable wall is opposed to a slidable wall, wherein the reversibly openable wall or part thereof comprises a folded closure comprising a flap.

48. The cartridge of claim 47 wherein said flap is adapted to fold at a hinge portion.

49.-59. (canceled)

60. The cartridge of claim 47 wherein the folded closure comprises:
(a) at least three flaps; or
(b) at least four flaps; or
(c) at least five flaps; or
(d) at least six flaps; or
(e) at least seven flaps; or
(f) at least eight flaps; or
(g) at least nine flaps; or
(h) at least ten flaps; or
(i) at least eleven flaps; or
(j) at least twelve flaps; or
(k) more than twelve flaps.

61. The cartridge of claim 60 wherein two or more of the flaps are mutually overlapping when folded into a closed configuration.

62. (canceled)

63. The cartridge of claim 60 wherein the flaps are sequentially overlapping when folded into a closed configuration.

64. The cartridge of claim 60 wherein said flaps are of uniform shape and/or are substantially rectangular or wedge-shaped.

65.-69. (canceled)

70. The cartridge of claim 47 wherein the slidable wall is adapted to slide towards the openable wall such that the plant materials can be displaced from the chamber when said openable wall is open.

71. (canceled)

72. The cartridge of claim 47 wherein the non-coffee plant materials are selected from:
(a) whole and/or cracked plant materials;
(b) unroasted plant materials, for example selected from: (i) green plant materials; (ii) dried plant materials; (iii) pre-heated plant materials; and (iv) mixtures of two or more of the foregoing;
(c) roasted plant materials;
(d) part-roasted plant materials;
(e) unground plant materials; and
(e) mixtures of the foregoing.

73. The cartridge of claim 72, wherein the plant materials are unroasted plant materials or part-roasted plant materials, for example selected from: (i) green plant materials; (ii) dried plant materials; (iii) pre-heated plant materials; and (iv) mixtures of two or more of the foregoing.

74. The cartridge of claim 47 wherein part or all of the cartridge is formed of materials selected from: paper, cardboard, coated paper or cardboard, and metal-, polytetrafluoroethylene- (PTFE-) or nitrocellulose-coated paper or cardboard.

75. (canceled)

76. The cartridge of claim 47, which is a disposable, single-serve cartridge.

77. The cartridge of claim 47 wherein one or more additives selected from flavouring agents, preservatives, foaming agents, anti-foaming agents, foam stabilizers, colouring agents and mixtures thereof are confined in the chamber of the cartridge together with the plant materials.

78. The cartridge of claim 77 wherein said one or more additives are selected from cocoa, caramel, vanilla, tea, chicory, fruit/berry extracts (e.g. raspberry, cherry, apricot, banana or citrus, such as lemon), herbs (for example mint), spices (for example, chilli and cinnamon, nutmeg), liqueurs (for example brandy and Amaretto), spirits (e.g. rum and brandy), salt, sugar, scorched sugar, honey, nuts (e.g. almond, hazelnut, walnut, peanut, pecan, macadamia and pistachio), coconut and mixtures of the foregoing.

79.-133. (canceled)

134. A process for producing and dispensing a herbal infusion comprising the step of grinding, extracting and optionally roasting unground plant materials contained in a cartridge as defined in claim 47.

135.-145. (canceled)

146. The process of claim of claim 134 wherein said herbal infusion comprises: (a) an extract of a medicinal plant; or (b) comprises a phytochemical extract comprising one or more alkaloids.
